(19) United States
(12) Patent Application Publication
(10) Pub. No.: US 2023/0325295 A1
(43) Pub. Date: Oct. 12, 2023

(54) INFORMATION PROCESSING SYSTEM, INFORMATION PROCESSING DEVICE, AND INFORMATION PROCESSING METHOD

(71) Applicant: Panasonic Intellectual Property Management Co., Ltd., Osaka (JP)

(72) Inventors: Yuya AOKI, KANAGAWA KEN (JP); Ikuya MITSUYA, KANAGAWA KEN (JP); Jiancong ZHAO, KANAGAWA KEN (JP); Takashi NISHIWAKI, OSAKA FU (JP); Syuhei YAMAOKA, TOKYO TO (JP)

(73) Assignee: Panasonic Intellectual Property Management Co., Ltd., Osaka (JP)

(21) Appl. No.: 18/208,699

(22) Filed: Jun. 12, 2023

Related U.S. Application Data
(63) Continuation of application No. PCT/JP2021/043472, filed on Nov. 26, 2021.

(30) Foreign Application Priority Data
Dec. 14, 2020 (JP) 2020-207106

(51) Int. Cl. G06F 11/34; G06F 9/455

(52) U.S. Cl. CPC G06F 11/3409; G06F 9/45558; G06F 2009/45595

(57) ABSTRACT

An information processing system according to the present disclosure includes one or more virtual machines and a hypervisor configured to control the one or more virtual machines. The information processing system includes a memory, and a hardware processor coupled to the memory. The hardware processor is configured to: acquire, from each of the one or more virtual machines and the hypervisor, first log information including operation information representing an operation state of the virtual machine or the hypervisor and time information corresponding to the operation information; and visualize the acquired first log information based on time input by a user.

### CROSS-REFERENCE TO RELATED APPLICATIONS

This application is a continuation of International Application No. PCT/JP2021/04372, filed on Nov. 26, 2021 which claims the benefit of priority of the prior Japanese Patent Application No. 2020-207106, filed on Dec. 14, 2020, the entire contents of which are incorporated herein by reference.

### FIELD

The present disclosure relates to an information processing system, an information processing device, and an information processing method.

### BACKGROUND

In the related art, as an electronic control device for a vehicle, there is known a technique of grasping an operation state from logs of a plurality of virtual machines to which the virtualization technology is applied, the virtual machines managed by a hypervisor in the electronic control device.

A conventional technique is disclosed in Japanese Patent Application Laid-open No. 2019-185130.

However, in a case of checking operation states of a plurality of virtual machines managed by a hypervisor, time and effort are required to be taken.

The present disclosure provides an information processing system, an information processing device, and an information processing method allowing to grasp an operation state of a virtual machine of an electronic control device for a vehicle to which the virtualization technology is applied.

### SUMMARY

An information processing system according to the present disclosure includes one or more virtual machines and a hypervisor configured to control the one or more virtual machines. The information processing system includes a memory, and a hardware processor coupled to the memory. The hardware processor is configured to: acquire, from each of the one or more virtual machines and the hypervisor, first log information including operation information representing an operation state of the virtual machine or the hypervisor and time information corresponding to the operation information; and visualize the acquired first log information based on time input by a user.

### BRIEF DESCRIPTION OF THE DRAWINGS

FIG. 1 is a system configuration diagram illustrating an example of an information processing system according to a first embodiment;

FIG. 2 is a diagram illustrating an example of a hardware configuration of an information processing device according to the first embodiment;

FIG. 3 is a diagram illustrating an example of a functional configuration of the information processing device according to the first embodiment;

FIG. 4 is a diagram illustrating an example of display of a display device in visualization processing performed by the information processing device according to the first embodiment;

FIG. 5 is a flowchart illustrating an example of a procedure of visualization processing performed by the information processing device according to the first embodiment;

FIG. 6 is a diagram illustrating an example of a functional configuration of an information processing device according to a second embodiment;

FIGS. 7A and 7B are diagrams illustrating an example of display of a display device in visualization processing performed by the information processing device according to the second embodiment; and

FIG. 8 is a flowchart illustrating an example of a procedure of visualization processing performed by the information processing device according to the second embodiment.

### DETAILED DESCRIPTION

The following describes embodiments of an information processing system, an information processing device, and an information processing method according to the present disclosure with reference to the drawings.

(First Embodiment)

The following describes a first embodiment with reference to the drawings.

(Configuration Diagram of Information Processing System)

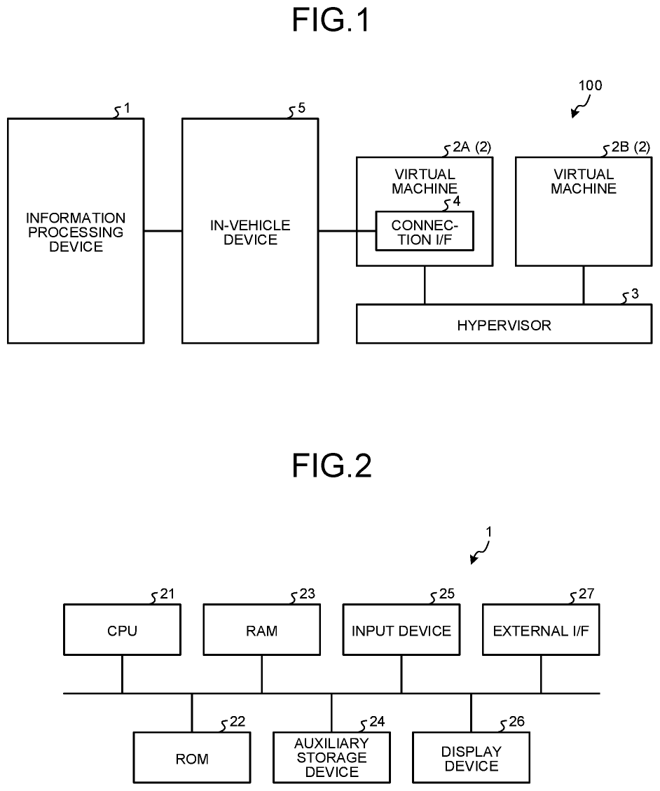

FIG. 1 is a system configuration diagram illustrating an example of an information processing system 100 according to the first embodiment. As illustrated in FIG. 1, the information processing system 100 includes an information processing device 1, a plurality of virtual machines 2, a hypervisor 3, and an in-vehicle device 5.

The information processing device 1 is connected to software in the virtual machine via a physical interface of the in-vehicle device 5, for example, and performs control such that, when a user inputs time via an input device of the information processing device 1, log information of the virtual machine and the hypervisor is visualized based on the time input by the user, for example. Detailed content will be described later.

The virtual machines 2 are connected to the hypervisor 3, for example, and the virtual machines 2 control the in-vehicle device 5 provided in a vehicle. A virtual machine 2A includes a connection I/F 4 connected to the in-vehicle device 5. The connection I/F 4 may be connected to the information processing device 1.

FIG. 1 exemplifies a configuration in which the information processing system 100 includes the virtual machine 2A and a virtual machine 2B as the virtual machines 2. However, the number of the virtual machines 2 included in the information processing system 100 is not limited thereto.

The hypervisor 3 is, for example, connected to the virtual machines 2, and the hypervisor 3 performs control to implement the virtual machines 2.

FIG. 1 exemplifies a configuration in which the information processing system 100 includes the hypervisor 3. However, the number of hypervisors 3 included in the information processing system 100 is not limited thereto.

Examples of the in-vehicle device 5 include an in-vehicle information device that is provided in the vehicle and connected to the virtual machine 2, for example. FIG. 1 exemplifies a configuration in which the information processing system 100 includes the in-vehicle device 5. However, the number of in-vehicle devices 5 included in the information processing system 100 and a function thereof are not limited thereto.

(Hardware Configuration Example of Information Processing Device)

FIG. 2 is a diagram illustrating an example of a hardware configuration of the information processing device 1 according to the first embodiment. As illustrated in FIG. 2, the information processing device 1 includes a central processing unit (CPU) 21, a read only memory (ROM) 22, a random access memory (RAM) 23, an auxiliary storage device 24, an input device 25, a display device 26, and an external I/F 27.

The CPU 21 integrally controls an operation of the information processing device 1 by executing a computer program, and implements various functions of the information processing device 1. The various functions of the information processing device 1 will be described later.

The ROM 22 is a non-volatile memory, and stores various kinds of data (information that is written at a manufacturing stage of the information processing device 1) including a computer program for starting the information processing device 1. The RAM 23 is a volatile memory including a working area for the CPU 21. The auxiliary storage device 24 stores various kinds of data such as a computer program executed by the CPU 21. The auxiliary storage device 24 is constituted of a hard disc drive (HDD), for example.

The input device 25 is a device with which the user who uses the information processing device 1 performs various operations. The input device 25 is constituted of a keyboard or a touch panel, for example.

The display device 26 displays visualized various kinds of information including second log information of the virtual machine 2 and the hypervisor 3 based on the time input to the input device 25 by the user. The display device 26 is constituted of a liquid crystal display, for example. The input device 25 and the display device 26 may be integrally configured like a form of a touch panel, for example.

The external I/F 27 is an interface for connecting (communicating) with an external device such as the hypervisor 4, and performs communication on a local area network (LAN), for example.

(Function Example of Information Processing Device)

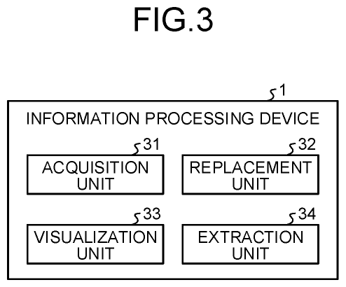

Next, FIG. 3 is a diagram illustrating an example of a functional configuration of the information processing device 1 according to the first embodiment. In the example of FIG. 3, only functions related to the present embodiment are exemplified, but functions of the information processing device 1 are not limited thereto. As illustrated in FIG. 3, the information processing device 1 includes an acquisition unit 31, a replacement unit 32, a visualization unit 33, and an extraction unit 34.

The acquisition unit 31 has a function of acquiring first log information including operation information representing an operation state of the virtual machine 2 or the hypervisor 3 and time information corresponding to the operation information from each of the one or more virtual machines 2 and the hypervisor 3. In the first log information, for example, recorded is content of an operation in which internal processing of the virtual machine 2 and the hypervisor 3 is performed. The first log information may also include performance information representing a performance state of the one or more virtual machines and the hypervisor.

The replacement unit 32 has a replacement function of replacing the time information included in the first log information acquired by the acquisition unit 31 with relative time information indicating relative time based on reference time information, and generating the second log information including the operation information and the relative time information corresponding to the operation information. By generating the second log information by replacing the time information included in the first log information with the relative time information, pieces of data can be aligned on a time-series basis based on the relative time information at the time of performing visualization processing. The replacement unit 32 may have a function for each of the virtual machine 2 and the hypervisor 3.

The replacement unit 32 may also have a function of generating and acquiring the second log information. The second log information may be replaced with the first log information at a timing at which the first log information is output from the virtual machine 2 and the hypervisor 3.

Furthermore, the second log information may include performance information representing a performance state of the one or more virtual machines and the hypervisor. When the second log information includes the performance information representing the performance state of the one or more virtual machines and the hypervisor, operation states of the one or more virtual machines and the hypervisor and the performance information of the one or more virtual machines and the hypervisor can be checked without taking time and effort to analyze each piece of the log information.

The visualization unit 33 visualizes the first log information acquired by the acquisition unit 31 based on the time input by the user. The visualization unit 33 also has a function of visualizing the second log information of the virtual machine 2 and the hypervisor 3 based on the time input by the user. The user inputs, to the input device 25, the time desired to be visualized, and the second log information is visualized on the display device 26 based on the relative time included in the second log information corresponding to the time input by the user. The visualization unit 33 may also have a playback position function of reproducing portions of the operation information and the performance information included in the second log information corresponding to the time designated by the user.

Herein, the playback position function is a display function of indicating, when information is visualized on the display device by visualization processing, a reproduction part of the displayed information, for example, and a seek bar and the like are provided corresponding to the visualized information. By reproducing the portions corresponding to the time designated by the user, a position to which the reproduction has been made can be visually grasped with a position of a slider.

By operating the slider, reproduction can be started from an optional point, and the information included in the second log information can be grasped without taking time and effort to analyze each piece of the log information.

The visualization unit 33 may visualize the second log information to be visualized while dividing the second log information into pieces of log information corresponding to content thereof, or may collectively display the second log information. For example, in units of output log information, the second log information of the virtual machine 2 and the second log information of the hypervisor 3 may be separately visualized. In a case of dividing content described in the second log information, for example, information indicating the operation state of the second log information may be visualized as operation states of the virtual machine 2 and the hypervisor 3.

The extraction unit 34 has a function of extracting operation information corresponding to the time input by the user from the operation information included in the second log information of each of the one or more virtual machines 2 and the hypervisor 3. After the operation information is extracted, the visualization unit 33 visualizes the operation information extracted by the extraction unit 34. After the operation information corresponding to the time input by the user is extracted, by visualizing the extracted operation information, a burden of the visualization processing can be reduced, and the visualization processing can be efficiently performed.

(Example of Display Form in Visualization Processing)

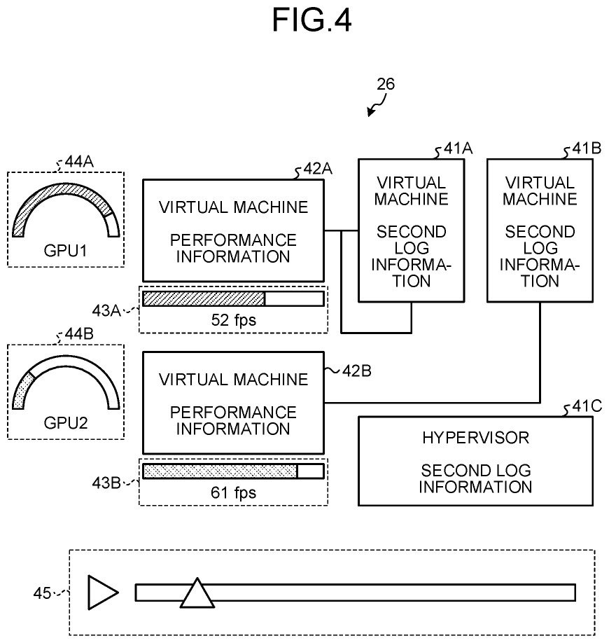

Next, the following describes an example of display of the display device 26 in visualization processing performed by the information processing device 1 with reference to FIG. 4.

As illustrated in FIG. 4, the display device 26 displays information in which respective pieces of the second log information (41A, 41B, 41C) of the one or more virtual machines 2 and the hypervisor 3 are visualized based on the time input by the user.

The display device 26 also displays pieces of performance information (42A, 42B) included in the respective pieces of second log information (41A, 41B, 41C) of the virtual machines 2 and the hypervisor 3 based on the time input by the user.

The display device 26 also displays ratios and numerical values (43A, 43B) included in the pieces of performance information (42A, 42B) included in the respective pieces of second log information (41A, 41B, 41C) of the virtual machines 2 and the hypervisor 3 based on the time input by the user.

Herein, as an example of the performance information (42A, 42B), exemplified is a frame rate (frames per second: fps) representing the number of times of continuous display per one second of individual static images constituting a moving image as an indicator representing smoothness of the moving image. The performance information (42A, 42B) is not limited to the frame rate. The numerical values (43A, 43B) are displayed under the respective pieces of performance information (42A, 42B), but display positions of the numerical values 43 are not limited thereto.

The display device 26 displays output ratios (44A, 44B) of performance included in the pieces of performance information (42A, 42B) included in the respective pieces of second log information (41A, 41B, 41C) of the virtual machines 2 and the hypervisor 3 based on the time input by the user.

Herein, as an example of the performance information (42A, 42B), displayed is the output ratios (44A, 44B) of a graphics processing unit (GPU) of an arithmetic device specialized in image processing as an in-vehicle device. The output ratios (44A, 44B) are not limited to output ratios of the GPU.

The output ratio 44 is displayed on a side of the performance information 42 assuming that the output ratio 44A is an output ratio of the performance information 42A and the output ratio 44B is an output ratio of the performance information 42B. A display position of the output ratio 44 is not limited thereto.

The display device 26 displays a playback position function 45 for reproducing portions of the operation information and the performance information (42A, 42B) included in the second log information corresponding to the time designated by the user. Herein, a seek bar is provided as an example of the playback position function 45. The playback position function 45 is not limited to the seek bar, but includes a function that can reconstruct the playback position based on a time input by the user. By providing the playback position function 45, the portions corresponding to the time designated by the user is linked with the operation states of the virtual machine 2 and the hypervisor 3, so that the user can grasp consumption of resources of the virtual machine 2 and the hypervisor 3 without taking time and effort.

(Example of Visualization Processing Performed by Information Processing System)

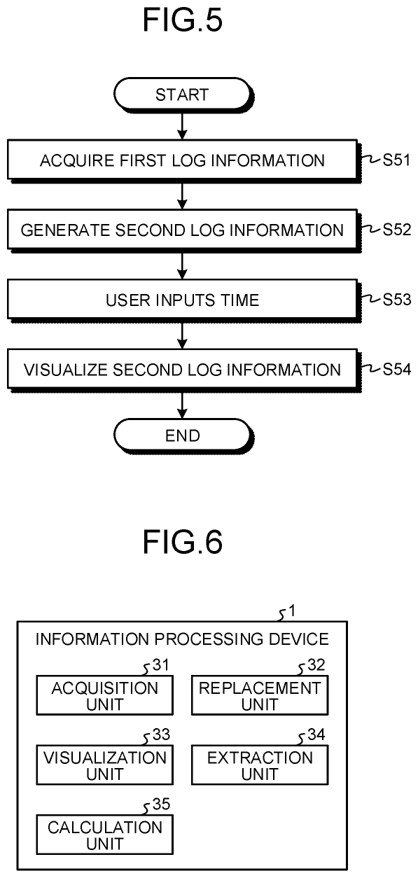

FIG. 5 is a flowchart illustrating an example of a procedure of visualization processing performed by the information processing device 1 according to the present embodiment.

First, at Step S51, the first log information is acquired from each of the one or more virtual machines 2 and the hypervisor 3, the first log information including the operation information representing the operation state of the virtual machine 2 or the hypervisor 3 and the time information corresponding to the operation information (Step S51). After the first log information is acquired, the process proceeds to Step S52.

Next, at Step S52, the time information included in the acquired first log information is replaced with relative time information indicating relative time based on reference time information, and the second log information including the operation information and the relative time information corresponding to the operation information is generated (Step S52). After the second log information is generated, the process proceeds to Step S53.

Next, at Step S53, the user inputs the time designated by the user via the input device 25 (Step S53). After the user inputs the time, the process proceeds to Step S54.

Next, at Step S54, the second log information of each of the one or more virtual machines and the hypervisor is visualized based on the time input by the user (Step S54). After the second log information is visualized, the visualization processing performed by the information processing system 100 ends.

In this way, the information processing device 1 according to the first embodiment acquires the first log information including the operation information and the time information from each of the one or more virtual machines and the hypervisor. The information processing device 1 then visualizes the first log information based on the time input by the user.

Due to this, it is possible to easily extract and visualize the information corresponding to the time designated by the user from the operation information included in each piece of the log information without taking time and effort to analyze the log information of each of the one or more virtual machines and the hypervisor.

(Second Embodiment)

The following describes a second embodiment with reference to the drawings.

Next, the following describes the second embodiment. Description about portions common to the first embodiment described above is appropriately omitted. In the first embodiment described above, the information processing system includes the one or more virtual machines and the hypervisor that controls the one or more virtual machines, and further includes an acquisition unit that acquires the first log information including the operation information representing the operation state of the virtual machine or the hypervisor and the time information corresponding to the operation information from each of the one or more virtual machines and the hypervisor, and the visualization unit that visualizes the first log information acquired by the acquisition unit based on the time input by the user.

On the other hand, the present embodiment is different from the first embodiment described above in that the information processing device 1 further includes a calculation unit 35, the second log information includes event information representing a history of a connection from the virtual machine 2 to one or more in-vehicle devices 5, and an overhead value at the time when a connection from the virtual machine 2 to the in-vehicle device 5 is made is calculated based on the relative time information corresponding to the event information.

(Function Example of Information Processing Device)

FIG. 6 is a diagram illustrating an example of functions of the information processing device 1 according to the second embodiment. The calculation unit 35 of the information processing device 1 according to the second embodiment includes the event information representing a history of a connection from the virtual machine 2 to the one or more in-vehicle devices 5 in the second log information, and calculates the overhead value at the time when a connection from the virtual machine 2 to the in-vehicle device 5 is made based on the relative time information corresponding to the event information. The calculation unit 35 may also calculate route information from the virtual machine 2 to the in-vehicle device 5 based on the event information representing that the connection from the virtual machine 2 to the in-vehicle device 5 is made. By calculating the route information, check can be easily performed without taking time and effort to analyze each piece of the log information.

(Example of Display Form in Visualization Processing)

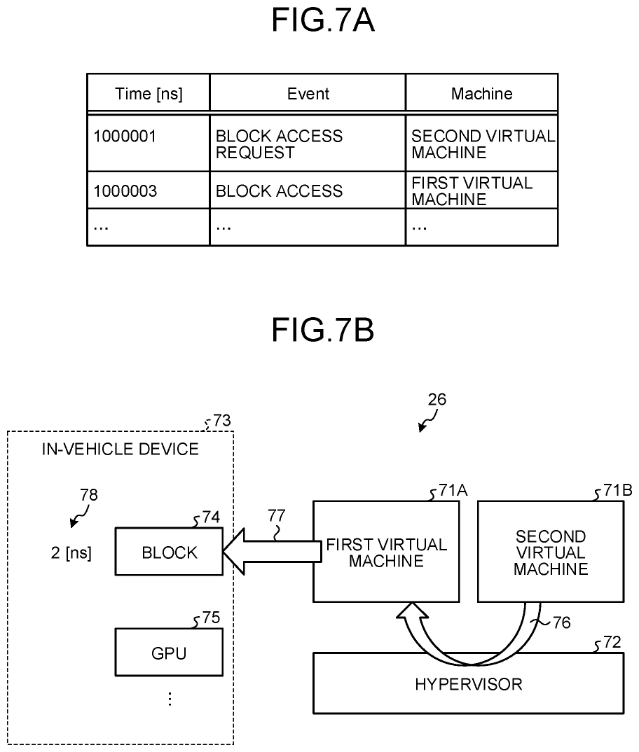

Next, the following describes an example of display of the display device 26 in visualization processing performed by the information processing device 1 with reference to FIGS. 7A and 7B.

FIG. 7A is an example of extracting, from the second log information, a log of a connection from the virtual machine 2 to the in-vehicle device 5. In FIG. 7A, Time [ns (nanosecond)] represents generation time, Event represents an event generated by a target device, and Machine represents the target device. Herein, illustrated is the fact that a connection request is made from a “second virtual machine” to “BLOCK” of an in-vehicle device 73 at time “100001”, and a connection from a “first virtual machine” to “BLOCK” of the in-vehicle device 73 is made at time “1000003”.

In FIG. 7B, a route of the connection from any of virtual machines (71A, 71B) to the in-vehicle device 73 is specified based on the event information and the time when the connection from the virtual machine (71A, 71B) to the in-vehicle device 73 is made in the log information illustrated in FIG. 7A based on the time input by the user, and a calculated overhead value 78 is visualized.

Herein, when the connection is made from the second virtual machine 71B to BLOCK 74 of the in-vehicle device 73, first, the connection is made from the second virtual machine 71B to a hypervisor 72 (route 76), the connection is made from the hypervisor 72 to the first virtual machine 71A (route 76), and the connection is made from the first virtual machine 71A to the BLOCK 74 of the in-vehicle device 73 (route 77) as a connection route.

As the overhead value 78, the overhead value 78 at the time when the connection is made from the second virtual machine 71B to the BLOCK 74 in the in-vehicle device 73 is calculated to be 2 [ns(nanoseconds)] based on a difference between Times in FIG. 7A.

In the present embodiment, routes (76, 77) are represented in a form of an arrow, but a display form of the route is not limited thereto. The overhead value 78 is displayed on a side of the connected BLOCK 74 in the in-vehicle device 73, but a display form is not limited thereto.

(Example of Visualization Processing Performed by Information Processing System)

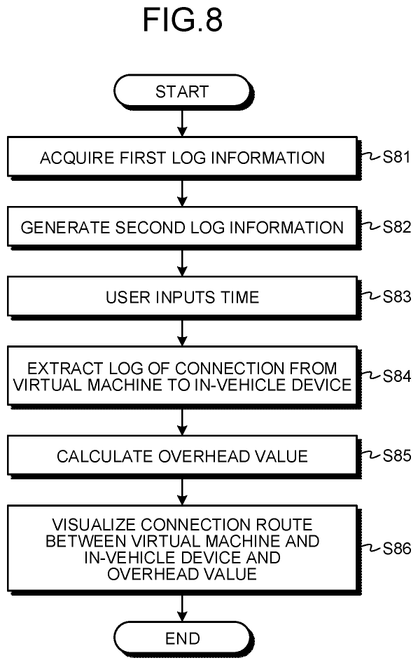

FIG. 8 is a flowchart illustrating an example of a procedure of visualization processing performed by the information processing device 1 according to the second embodiment.

First, at Step S81, the first log information is acquired from each of the one or more virtual machines 2 and the hypervisor 3, the first log information including the operation information representing the operation state of the virtual machine 2 or the hypervisor 3 and the time information corresponding to the operation information (Step S81). After the first log information is acquired, the process proceeds to Step S82.

Next, at Step S82, the time information included in the acquired first log information is replaced with relative time information indicating relative time based on reference time information, and the second log information including the operation information and the relative time information corresponding to the operation information is generated (Step S82). After the second log information is generated, the process proceeds to Step S83.

Next, at Step S83, the user inputs the time designated by the user via the input device 25 (Step S83). After the user inputs the time, the process proceeds to Step S84.

Next, at Step S84, a log of a connection from the virtual machine 2 to the in-vehicle device 5 is extracted from the second log information. After the log of the connection from the virtual machine 2 to the in-vehicle device 5 is extracted, the process proceeds to Step S85.

Next, at Step S85, from the event information representing a history of the connection from the virtual machine 2 to the one or more in-vehicle devices 5 in the log extracted at Step S84, a route is specified as to from which of the virtual machines 2 the connection has been made to the in-vehicle device 5 based on the relative time information corresponding to the event information, and the overhead value is calculated. After the overhead value is calculated from the event information and the time when connection from the virtual machine 2 to the in-vehicle device 5 is made, the process proceeds to Step S86.

Next, at Step S86, as a result calculated from the second log information of each of the one or more virtual machines and the hypervisor based on the time input by the user, the route of the connection from the virtual machine 2 to the in-vehicle device 5 and the overhead value thereof are visualized (Step S86). After the route of the connection from the virtual machine 2 to the in-vehicle device 5 and the overhead value thereof are visualized, the visualization processing performed by the information processing system 100 ends.

In this way, the information processing device 1 according to the second embodiment calculates the overhead value at the time when the connection from the virtual machine to the in-vehicle device is made based on the log information including the event information representing a history of the connection from the virtual machine to the one or more in-vehicle devices and the relative time information corresponding to the event information.

Due to this, it is possible to easily refer to the overhead value at the time when the connection from the virtual machine to the in-vehicle device is made based on the relative time information corresponding to the event information without taking time and effort to analyze, for each history, the event information representing a history of the connection from the virtual machine to the one or more in-vehicle devices.

The computer program executed by the information processing system according to the present embodiment is embedded and provided in a ROM, for example.

The computer program executed by the information processing system according to the present embodiment may be recorded and provided in a computer-readable recording medium such as a CD-ROM, a flexible disk (FD), a CD-R, and a digital versatile disc (DVD) as an installable or executable file.

Furthermore, the computer program executed by the information processing system according to the present embodiment may be stored in a computer connected to a network such as the Internet, and provided by being downloaded via the network. The computer program executed by the information processing system according to the present embodiment may be provided or distributed via a network such as the Internet.

The embodiments of the present invention have been described above. These embodiments are merely examples, and do not intend to limit the scope of the invention. These embodiments can be implemented in various other forms, and can be variously omitted, replaced, and modified without departing from the gist of the invention. These embodiments and modifications thereof are encompassed by the scope and the gist of the invention, and also encompassed by the invention described in CLAIMS and an equivalent thereof.

With the information processing system, the information processing device, and the information processing method according to the present disclosure, it is possible to grasp an operation state of a virtual machine of an electronic control device for a vehicle to which the virtualization technology is applied, without taking time and effort to check the operation state of the virtual machine.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing system including one or more virtual machines and a hypervisor configured to control the one or more virtual machines, the information processing system comprising:
a memory; and
a hardware processor coupled to the memory,
the hardware processor being configured to:
acquire, from each of the one or more virtual machines and the hypervisor, first log information including operation information representing an operation state of the virtual machine or the hypervisor and time information corresponding to the operation information; and
visualize the acquired first log information based on time input by a user.

2. The information processing system according to claim 1, wherein the hardware processor is further configured to:
replace the time information included in the acquired first log information with relative time information indicating relative time based on reference time information, and generate second log information including the operation information and the relative time information corresponding to the operation information; and
visualize the second log information of each of the one or more virtual machines and the hypervisor.

3. The information processing system according to claim 2, wherein the hardware processor is further configured to:
extract the operation information corresponding to the time input by the user from the operation information included in the second log information of each of the one or more virtual machines and the hypervisor; and
visualize the extracted operation information.

4. The information processing system according to claim 2, wherein the second log information includes performance information representing a performance state of the virtual machine.

5. The information processing system according to claim 4, wherein the hardware processor has a playback position function of reproducing portions of the operation information and the performance information included in the second log information corresponding to time designated by the user.

6. The information processing system according to claim 1, wherein the hardware processor has a playback position function of reproducing a portion of the operation information included in the first log information corresponding to time designated by the user.

7. The information processing system according to claim 2, wherein
the second log information includes event information representing a history of connections from the virtual machine to one or more in-vehicle devices, and
the hardware processor is further configured to calculate an overhead value at a time when a connection from the virtual machine to an in-vehicle device is made based on the relative time information corresponding to the event information.

8. An information processing device comprising:
a memory; and
a hardware processor coupled to the memory,
the hardware processor being configured to:
acquire, from each of one or more virtual machines and a hypervisor, first log information including operation information representing an operation state of the virtual machine or the hypervisor and time information corresponding to the operation information; and
visualize the acquired first log information based on time input by a user.

9. An information processing method comprising:
acquiring, from each of one or more virtual machines and a hypervisor, first log information including operation information representing an operation state of the virtual machine or the hypervisor and time information corresponding to the operation information; and
visualizing the first log information acquired at the acquiring, based on time input by a user.
